(19) United States
(12) Patent Application Publication
(10) Pub. No.: US 2020/0167253 A1
(43) Pub. Date: May 28, 2020

(54) REMOTE DIAGNOSIS SYSTEM AND METHOD FOR HARDWARE

(71) Applicants: INVENTEC (PUDONG) TECHNOLOGY CORPORATION, Shanghai City (CN); INVENTEC CORPORATION, Taipei City (TW)

(72) Inventors: Chao-Wei CHANG, Taipei City (TW); Wen-Chiang FAN, Taipei City (TW); Shan-Heng WU, Taipei City (TW)

(73) Assignees: INVENTEC (PUDONG) TECHNOLOGY CORPORATION, Shanghai City (CN); INVENTEC CORPORATION, Taipei City (TW)

(21) Appl. No.: 16/219,082

(22) Filed: Dec. 13, 2018

(30) Foreign Application Priority Data
Nov. 27, 2018 (CN) 201811426586.2

(51) Int. Cl. G06F 11/22; G06F 11/07; G06F 11/14

(52) U.S. Cl. CPC G06F 11/2294; G06F 11/0748; G06F 11/079; G06F 11/0778; G06F 11/1417

(57) ABSTRACT

A method for remote diagnosis for hardware, generating a trigger command by a remote management device comprising a plurality of candidate commands for triggering a baseboard management controller when the remote management device receives a user command, and sending a executing command to a BIOS by the triggered baseboard management controller; performing a diagnosis process and generating a diagnosis message according to the diagnosis process based on a boot code of the BIOS by the server, and then sending the diagnosis message to the baseboard management controller by the BIOS. Storing the diagnosis message by the baseboard management controller, and sending a feedback command to the remote management device after the baseboard management controller stores the diagnosis message, and then generating a feedback message by the remote management device.

### CROSS-REFERENCE TO RELATED APPLICATIONS

This non-provisional application claims priority under 35 U.S.C. § 119(a) on Patent Application No(s). 201811426586.2 filed in China on 27, Nov. 2018 the entire contents of which are hereby incorporated by reference.

### BACKGROUND

### 1. Technical Field

The disclosure relates to a system with the function of the remote diagnosis and the method for hardware, more particularly to a diagnosis system and the method for hardware performed remotely.

### 2. Related Art

Due to the demand of the technology nowadays, the computers have been widely applied in different fields. For example, the personal computer (PC) with simpler configuration or the server system with more complex configuration. By the integration of the hardware, software and network resource, lots of complex work is able to be finished effectively via aforementioned or other kinds of computers. However, since the configuration of the server system is complex, it needs lots of time for solving the problem when the server system malfunctions. Specifically, if the malfunction is occurred during the booting process, or more particularly, if the malfunction occurred during the booting process is too serious and makes the server can not be turned on completely, the corresponding functions are not able to be supplied, and other damage (such as the losing file, the damaged hardware, or the expensive cost for repairing the server, etc.) is difficult to estimate.

As the server system malfunctions, the troubleshooting is poften performed by the remote diagnosis for hardware. Although the remote diagnosis for hardware is easier to be performed than the on-site diagnosis, it needs the detailed operation codes before the server system malfunctions for solving the problem efficiently. Also, the remote diagnosis for hardware must be performed in the condition that the server is able to be turned on and is able to be connected to the network. Furthermore, it needs a period of time for performing the remote diagnosis, so the work progress of the user may be delayed.

As a result, it still needs a remote diagnosis system and the method for hardware, as the user turns on the server each time, the diagnosis process is able to be performed automatically and the detailed code is able to be listed and stored, and the technical staff is able to do the troubleshooting remotely according to detailed code. Also, the diagnosis process is able to be classified into different levels based on different requirement, so the user is able to choose the proper diagnosis level so as to avoid wasting the time and the computer resource.

### SUMMARY

Accordingly, this disclosure provides a remote diagnosis system and a method for hardware, the hardware state is able to be listed and stored during each time of turning on the server, and the technical staff is able to do the troubleshooting according to the stored hardware state as the server malfunctions in the future.

According to one or more embodiment of this disclosure, a remote diagnosis method for hardware, comprising: when the remote management device receives a user command, one of a plurality of candidate commands is chosen by a remote management device for generating and outputting a trigger command so as to trigger a baseboard management controller of a server, the triggered baseboard management controller sends an executing command to a BIOS. Also, a diagnosis message is generated by the server after the BIOS receives the executing command, and a diagnosis process is performed by the server when the server performs a boot code of the BIOS. Furthermore, the BIOS sends the diagnosis message to the baseboard management controller after the server finishes the diagnosis process, the baseboard management controller receiving the diagnosis message stores the diagnosis message, and the baseboard management controller sends a feedback command to the remote management device after the baseboard management controller stores the diagnosis message. In addition, the remote management device generates a feedback message after the remote management device receives the feedback command.

According to one or more embodiment of this disclosure, a remote diagnosis system for hardware comprises a server and a remote management device, wherein the server comprises: a baseboard management controller adapted for receiving a trigger command and generating an executing command, with the baseboard management controller receiving and storing a diagnosis message and generating a feedback command; and a BIOS electrically connected to the baseboard management controller, with the BIOS storing a boot code, and the server performing a diagnosis process according to the executing command when the server performs the boot code of the BIOS, with the server generating the diagnosis message according to the diagnosis process. Also, the remote management device is communicatively connected to the server through a network, the remote management device comprises a plurality of candidate commands, the remote management device chooses one of the candidate commands for generating and outputting the trigger command to the remote management device when the remote management device receives a user command, and the remote management device generates a feedback message after the remote management device receives the feedback command.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is the structure diagram of the remote diagnosis system for hardware according to an embodiment of this disclosure.

FIG. 2 is the flowchart of the remote diagnosis method for hardware according to an embodiment of this disclosure.

FIG. 3 shows the details of a part of the flowchart of the remote diagnosis method for hardware according to an embodiment of this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

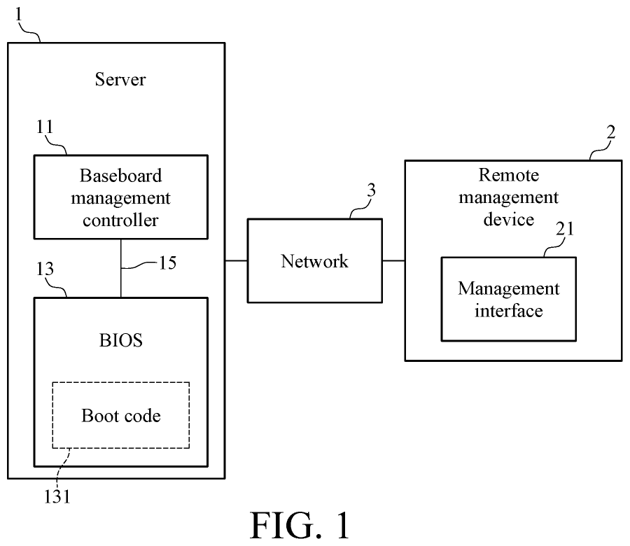

Please refer to FIG. 1, and FIG. 1 is the structure diagram of the remote diagnosis system for hardware according to an embodiment of this disclosure. The remote diagnosis system for hardware comprises a server 1 and a remote management device 2. The server 1 may be any device with the computing function, such as the server system, and the server 1 includes a baseboard management controller 11, a BIOS 13 and a serial port 15. Moreover, the remote management device 2 comprises a management interface 21, and the remote management device 2 is communicatively connected to the server 1 through a network 3, so the server 1 may be operated remotely by the emote management device 2. Through each of aforementioned elements, the server 1 is able to be performed a diagnosis process during the booting process so as to detect and store the states of each hardware. Also, the remote management device 2 is able to obtain the corresponding information of the diagnosis process of the server 1. The connections between each aforementioned element are illustrated hereinbelow.

For specific descriptions of the elements of the server 1, please continue to refer FIG. 1. The baseboard management controller 11 may be a BMC, the baseboard management controller 11 is adapted for receiving a trigger command and generating a executing command. Also, after the diagnosis process is finished, the baseboard management controller 11 receives a diagnosis message and generates a feedback command according to the diagnosis message. Moreover, the BIOS 13 may be a BIOS chipset (basic input/output system chipset), the BIOS 13 is electrically connected to the baseboard management controller 11 and stores a boot code 131. When the server 1 performs the boot code 131, the server 1 performs the diagnosis process after the BIOS 13 receives the executing command, and the server 1 generates the diagnosis message according to the diagnosis process. Furthermore, there includes a serial port 15 between the BIOS 13 and the baseboard management controller 11, wherein the BIOS 13 sends the diagnosis message to the baseboard management controller 11 through a serial port 15, and the baseboard management controller 11 receives and stores the diagnosis message in order to be used for the troubleshooting in the future.

For particular descriptions for the elements of the remote management device 2, please continue to refer FIG. 1. When the server 1 malfunctions and is not able to be turned on, the technical staff is able to generate a user command through the remote management device 2 for triggering the server 1 to perform the diagnosis process. Particularly, the remote management device 2 has a plurality of candidate commands, the technical staff is able to generate the user command by the remote management device 2, and the remote management device 2 chooses one of the candidate commands to generate a trigger command for triggering the server 1 to perform the diagnosis process. Additionally, after the diagnosis process is finished, the remote management device 2 is able to receive a feedback command and generate a feedback message, and the technical staff could obtain the information about the diagnosis process from the feedback message of the remote management device 2. After the server 1 finishes the diagnosis process and stores the diagnosis message in the baseboard management controller 11, the management interface 21 of the remote management device 2 is able to selectively generate a user command, and the remote management device 2 is able to obtain the diagnosis message stored in the baseboard management controller 11 of the server 1 through the user command. It should be noticed that, the user command may be the internet protocol address (IP) of the server 1 herein. Hence, the diagnosis message is able to be obtained remotely through the technical staff operating the remote management device 2, and the technical staff is able to help the user to process the troubleshooting on the server according to the information of the diagnosis message.

In addition, if the server 1 is not able to finish the complete booting process due to the malfunction, and the server 1 may only finish the parts of the diagnosis process and generate corresponding diagnosis message due to aforementioned reason, the diagnosis message still could be stored in the baseboard management controller 11. Also, the server 1 sends the user command by the management interface 21 of the remote management device 2, so the remote management device 2 could obtain aforementioned diagnosis message. On the other hand, the diagnosis message is stored in the baseboard management controller 11, and the operation of the baseboard management controller 11 is independent and separate from the CPU (central processing unit) and the OS (operating system) of the server 1. As a result, although the server 1 is not able to be turned on due to the serious malfunction, the remote management device 2 is still able to sends the user command through the management interface 21, and the remote management device 2 could obtain the diagnosis message stored in the baseboard management controller 11 previously.

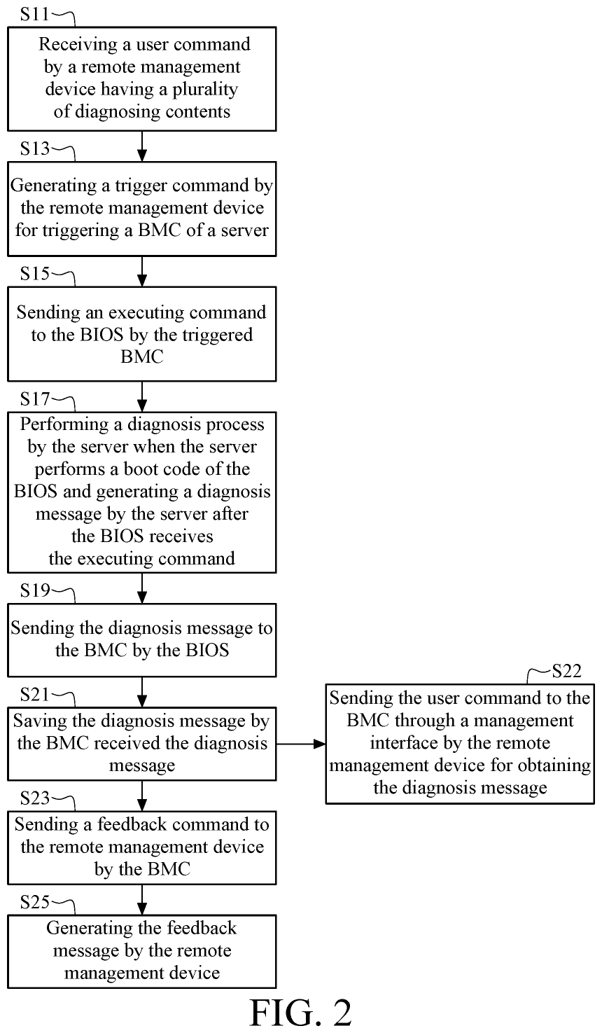

Please refer to FIG. 2, and FIG. 2 is the flowchart of the remote diagnosis method for hardware according to an embodiment of this disclosure. For the step S11: the remote management device 2 having the plurality of candidate commands receives the user command; wherein the user command is adapted for choosing one of the candidate commands, and the remote management device 2 generates and outputs the trigger command. After the remote management device 2 generates and outputs the trigger command, please refer to the step S13: the remote management device 2 generates the trigger command and triggers the baseboard management controller 11 of the server 1; wherein the trigger command is sent to the baseboard management controller 11 of the server 1 through the network 3. After the BIOS 13 receives the trigger command, please refer to the step S15: the triggered baseboard management controller 11 sends the executing command to the BIOS 13; wherein the executing command is sent through the serial port 15. Continuing from the previous step, please refer to step S17: the server 1 performs the diagnosis process based on the boot code 131 of the BIOS 13, and the server 1 generates the diagnosis message according to the diagnosis process; wherein the diagnosis message is noted and listed the hardware states when the boot code 131 performed by the server 1. After the server 1 generates the diagnosis message, please refer to the step S19: the BIOS 13 sends the diagnosis message to the baseboard management controller 11, and for the step S21: the baseboard management controller 11 received the diagnosis message stores the diagnosis message, and the remote diagnosis for the hardware could be performed based on the diagnosis message in the future. Also, after the baseboard management controller 11 stores the diagnosis message, please refer to the step S22: the remote management device 2 sends the user command through the management interface 21 for obtaining the diagnosis message; wherein the remote management device 2 is able to be communicatively connected to the server 1 through the network 3. Therefore, the technical staff could obtain the diagnosis message stored in the baseboard management controller 11 of the server through the management interface 21 of the remote management device 2, and the technical staff is able to help the user to perform the troubleshooting. For these reasons, the contents of the diagnosis message may be shown in the form of the program language, and the technical staff is able to perform the troubleshooting correctly according to the diagnosis message. Furthermore, after the baseboard management controller 11 stores the diagnosis message, please refer to the step S23: the baseboard management controller 11 sends the feedback command to the remote management device 2, wherein the feedback command is associated with the diagnosis message, and the feedback command may be adapted for informing the remote management device 2 that the diagnosis process is finished. For the step S25: the remote management device 2 generates the feedback message, and the feedback message is generated according to the feedback command by the remote management device 2; hence, the diagnosis result is able to be informed to the user using the server 1 through the feedback message. For these reasons, the contents of the feedback message may be shown by the common words which are easily understand for the users who do not have the technical background, so the users may read the feedback message and perform some simple troubleshooting by themselves. On the other hand, the feedback message is also adapted for informing the remote management device 2: the diagnosis process just finished by the server 1, and the technical staff operating the remote management device 2 is able to know the simple information about the diagnosis process just finished through the feedback message.

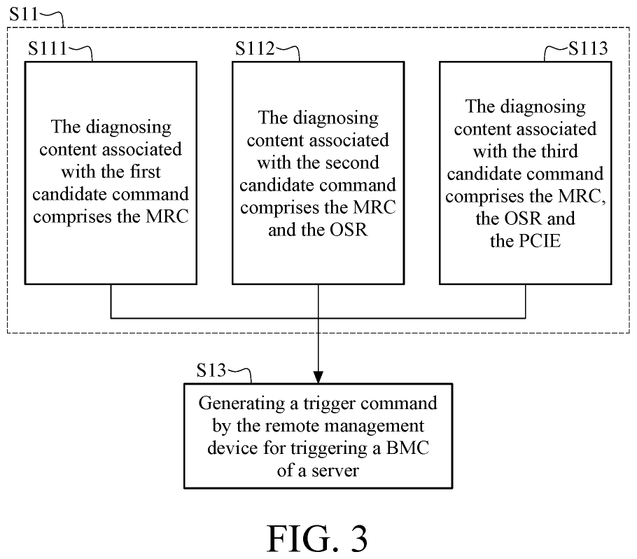

In aforementioned embodiment, the purpose of performing the step S11 is to make the technical staff operating the remote management device 2 able to choose the proper diagnosing content according to different requirements; therefore, the performing time of the diagnosis process is able to be shorten, and the hardware damaging during the diagnosis process is able to be decreased. Hereinbelow, the specific descriptions for implementing the step S11 are illustrated in the following embodiment, but the step S11 is not limitative in the following embodiment. Please refer to FIG. 1 and FIG. 3, and FIG. 3 shows the details of a part of the flowchart for the step S11 of the remote diagnosis method for hardware according to an embodiment of this disclosure. According to the remote management device 2 hereinbefore, the candidate commands are associated with a plurality of different diagnosing contents; after the remote management device 2 receives the user command, and the remote management device 2 chooses one of the candidate commands for generating the trigger command. Aforementioned the plurality of candidate commands comprise: a first candidate command, a second candidate command and a third candidate command; wherein the diagnosing content associated with the first candidate command includes a MRC (memory reference code), the diagnosing content associated with the second candidate command includes the MRC(memory reference code) and an OSR (the OS reserved partition which is the abbreviation for the operating system reserved partition), and the diagnosing content associated with the third candidate command includes the MRC (memory reference code), the OSR (OS reserved partition) and a PCIE (peripheral component interconnect express). In addition, the OSR (OS reserved partition) may be the hardware adapted for the operating system, such as adapted for Microsoft operating system. Briefly, aforementioned first candidate command, second candidate command and third candidate command are corresponding to three different diagnosing contents, and the diagnosing contents may be classified into the mild diagnosis, the moderate diagnosis and the severe diagnosis. Specifically, the mild diagnosis performs the diagnosis process for the MRC (memory reference code), the diagnosing content of the moderate diagnosis includes the diagnosing contents of the mild diagnosis and the OSR (OS reserved partition), and the diagnosing content of the severe diagnosis includes the diagnosing contents of the moderate diagnosis and the PCIE (peripheral component interconnect express). As a result, the technical staff is able to choose proper diagnosing content according to different conditions in practice, so the efficiency of the booting process may be increased, and the hardware resource may also be saved. There are three candidate commands corresponding to three different diagnosing content disclosed in this disclosure, but the main concept of the diagnosis method is to classify the diagnosis process according to different diagnosing contents; as a result, any change of the number of the candidate commands or the diagnosing contents are not limited in this disclosure.

For the specific descriptions, please continue to refer FIG. 3. The step S11 is illustrated hereinbefore, so the corresponding descriptions are abridged in this paragraph. The step S111 to S113 describe different candidate commands corresponding to different diagnosing contents. Please refer to the step S111: the diagnosing content associated with the first candidate command comprises the MRC, wherein the MRC is the abbreviation for the memory reference code. The step S112: the diagnosing content associated with the second candidate command comprises the MRC and the OSR, wherein the OSR is the abbreviation for the operating system reserved partition. Also, the step S113: the diagnosing content associated with the third candidate command comprises the MRC, the OSR and the PCIE, wherein the PCIE is the abbreviation for the peripheral component interconnect express. Particularly, when the remote management device 2 chooses the first candidate command and sends the trigger command, the baseboard management controller 11 generates an executing command according to the trigger command, and the server 1 performs the diagnosis process according to the diagnosing content corresponding to the first candidate command. Since the following step is the same as aforementioned embodiment, the descriptions are abridged in this paragraph. Similarly, when the remote management device 2 chooses the second candidate command or the third candidate command and sends the trigger command, the server 1 is also able to perform the diagnosis process according to the diagnosing content corresponding to aforementioned candidate command.

The remote diagnosis system for hardware and the method thereof are disclosed in this disclosure, the diagnosis process is able to be perform automatically as the user turns on the server 1. If the server 1 malfunctions during the booting process, the diagnosis message of the unfinished diagnosis process are able to be stored automatically. Hence, the technical staff is able to perform the troubleshooting remotely according to the diagnosis message. Furthermore, there are different diagnosing contents able to be chosen based on different conditions in practice for avoiding consuming unnecessary time and the hardware resource of the diagnosis process.

The embodiments depicted above and the appended drawings are exemplary and are not intended to be exhaustive or to limit the scope of the present disclosure to the precise forms disclosed. Many modifications and variations are possible in view of the above teachings.

What is claimed is:

1. A remote diagnosis method for hardware, comprising:
choosing one of a plurality of candidate commands by a remote management device for generating and outputting a trigger command so as to trigger a baseboard management controller of a server when the remote management device receives a user command;
sending an executing command to a BIOS by the baseboard management controller which is triggered;
performing a diagnosis process by the server when the server performs a boot code of the BIOS and generating a diagnosis message by the server after the BIOS receives the executing command;
sending the diagnosis message to the baseboard management controller by the BIOS after the server finishes the diagnosis process;
storing the diagnosis message by the baseboard management controller receiving the diagnosis message;
sending a feedback command to the remote management device by the baseboard management controller after the baseboard management controller stores the diagnosis message; and
generating a feedback message by the remote management device after the remote management device receives the feedback command.

2. The remote diagnosis method according to claim 1, wherein the candidate commands are associated with a plurality of diagnosing contents respectively, and generating the trigger command by the remote management device having the candidate commands comprises: choosing one of the candidate commands as the trigger command by the remote management device.

3. The remote diagnosis method according to claim 2, wherein the candidate commands comprise a first candidate command, a second candidate command and a third candidate command, wherein the diagnosing content associated with the first candidate command comprises a memory reference code, the diagnosing content associated with the second candidate command comprises the memory reference code and an operating system reserved partition, and the diagnosing content associated with the third candidate command comprises the memory reference code, the operating system reserved partition and a peripheral component interconnect express.

4. The remote diagnosis method according to claim 1, wherein storing the diagnosis message by the baseboard management controller received the diagnosis message comprises:
sending the user command to the baseboard management controller through a management interface for obtaining the diagnosis message by the remote management device communicatively connected to the baseboard management controller.

5. The remote diagnosis method according to claim 1, further comprising:
sending the feedback message to the server by the remote management device after the remote management device generates the feedback message,
wherein the server is communicatively connected to the remote management device.

6. A remote diagnosis system for hardware, comprising:
a server, comprising:
a baseboard management controller adapted for receiving a trigger command and generating an executing command, with the baseboard management controller receiving and storing a diagnosis message and generating a feedback command; and
a BIOS electrically connected to the baseboard management controller, with the BIOS storing a boot code, and the server performing a diagnosis process according to the executing command when the server performs the boot code of the BIOS, with the server generating the diagnosis message according to the diagnosis process; and
a remote management device communicatively connected to the server through a network, the remote management device comprising a plurality of candidate commands, the remote management device choosing one of the candidate commands for generating and outputting the trigger command to the remote management device when the remote management device receives a user command, and the remote management device generating a feedback message after the remote management device receives the feedback command.

7. The remote diagnosis system according to claim 6, wherein the candidate commands are associated with a plurality of different diagnosing contents.

8. The remote diagnosis system according to claim 7, wherein the candidate commands comprise a first candidate command, a second candidate command and a third candidate command, the diagnosing content associated with the first candidate command comprises a memory reference code, the diagnosing content associated with the second candidate command comprises the memory reference code and an operating system reserved partition, and the diagnosing content associated with the third candidate command comprises the memory reference code, the operating system reserved partition and a peripheral component interconnect express.

9. The remote diagnosis system according to claim 6, wherein the remote management device further comprises a management interface, and the management interface generates the user command the management interface after the baseboard management controller receives the diagnosis message.

10. The remote diagnosis system according to claim 9, wherein the user command is sent to the baseboard management controller for obtaining the diagnosis message stored in the baseboard management controller.
